(19) United States
(12) Patent Application Publication
(10) Pub. No.: US 2023/0418608 A1
(43) Pub. Date: Dec. 28, 2023

(54) IMPLICIT MEMORY CORRUPTION DETECTION FOR CONDITIONAL DATA TYPES

(71) Applicant: Intel Corporation, Santa Clara, CA (US)

(72) Inventors: David M. Durham, Beaverton, OR (US); Michael LeMay, Hillsboro, OR (US); Karanvir Grewal, Hillsboro, OR (US)

(73) Assignee: Intel Corporation, Santa Clara, CA (US)

(21) Appl. No.: 17/848,142

(22) Filed: Jun. 23, 2022

(51) Int. Cl. G06F 9/30; G06F 9/38

(52) U.S. Cl. CPC G06F 9/30145; G06F 9/30029; G06F 9/30105; G06F 9/3836

(57) ABSTRACT

Techniques for an instruction for a conditional jump operation (such as a Jump True operation) to detect memory corruption are described. An example apparatus comprises decoder circuitry to decode a single instruction, the single instruction to include fields for identifiers of a source operand, a destination operand, and a field for an opcode, the opcode to indicate execution circuitry is to generate an exception when a value of the source operand is not a first value and not a second value, execute a next instruction when the value of the source operand is the first value, and jump to a destination indicated by the destination operand when the value of the source operand is the second value. Other examples are described and claimed.

### BACKGROUND

Memory may become corrupted due to viruses, vulnerabilities or exploits. Current approaches for detecting and/or deterring memory corruption result in unwanted additional overhead.

Some computing architectures are based on capability hardware enhanced reduced instruction set computing (RISC) instructions (CHERI) and a CHERI instruction set architecture (ISA). CHERI uses capabilities to detect memory safety violations. Another approach to checking memory integrity uses stored message authentication codes (MACs) to detect physical memory corruption. A third approach includes memory tagging to detect invalid data accesses by matching a tag in a pointer to a memory tag for every 16-byte granule of data stored in memory.

However, CHERI expands every pointer to 128 bits or more to include bounds and type information for a referenced data object, resulting in significant additional storage overhead. Memory integrity and memory tagging require additional storage and performance overhead due to loads and stores for accessing MACs and tags from sequestered memory. Memory tagging is also not capable of detecting physical memory corruption (e.g., actual data corruption).

### BRIEF DESCRIPTION OF DRAWINGS

Various examples in accordance with the present disclosure will be described with reference to the drawings, in which:

FIG. 1 is a block diagram of a computing system in one implementation.

FIG. 2 is a block diagram of an accelerator in one implementation.

FIG. 3 is a diagram of memory encryption using a tag in one implementation.

FIG. 4 is a flow diagram of a method to process a Jump True instruction in one implementation.

FIG. 5 is a block diagram of computing hardware to process a Jump True instruction in one implementation.

FIG. 6 is a flow diagram of a method to process a Jump True instruction in one implementation.

FIG. 7 is a flow diagram of another method to process a Jump True instruction in one implementation.

FIG. 8 illustrates an exemplary computing system.

FIG. 9 illustrates a block diagram of an example processor that may have more than one core and an integrated memory controller.

FIG. 10A is a block diagram illustrating both an exemplary in-order pipeline and an exemplary register renaming, out-of-order issue/execution pipeline according to examples.

FIG. 10B is a block diagram illustrating both an exemplary example of an in-order architecture core and an exemplary register renaming, out-of-order issue/execution architecture core to be included in a processor according to examples.

FIG. 11 illustrates examples of execution unit(s) circuitry.

FIG. 12 is a block diagram of a register architecture according to some examples.

FIG. 13 illustrates examples of an instruction format.

FIG. 14 illustrates examples of an addressing field.

FIG. 15 illustrates examples of a first prefix.

FIGS. 16A-16D illustrate examples of how the R, X, and B fields of the first prefix in FIG. 15 are used.

FIGS. 17A-B illustrate examples of a second prefix.

FIG. 18 illustrates examples of a third prefix.

FIG. 19 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory machine-readable storage media for a conditional jump (e.g., Jump True) operation in an instruction set of a computing system. An implementation of the conditional jump (e.g., Jump True) operation includes implicit detection of memory corruption due to viruses, vulnerabilities or exploits for corrupted Boolean and conditional data types.

Memory encryption using block ciphers spreads corruption of single bits of ciphertext over an entire block on decryption. This phenomenon may be used to detect when conditional variables are corrupted due to memory vulnerabilities, software bugs or exploits, or even physical tampering. A new instruction, called a Jump True instruction herein, can detect memory corruption of conditional data types, such as Boolean, and generate an exception as a zero-overhead extension to traditional compare and branch instructions.

The technology disclosed herein does not require the use of tags or extended pointers to detect memory corruption. Per object encryption allows detection of overflow/underflow and “use after free” attacks. Implicit checks in the Jump True instruction determining the correctness of a conditional data type provides for zero overhead detection of memory corruption.

According to some examples, the technologies described herein may be implemented in one or more electronic devices. Non-limiting examples of electronic devices that may utilize the technologies described herein include any kind of computing system, mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, disaggregated server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide an instruction set for a Jump True operation.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some examples disclosed herein provide technology for a conditional jump (e.g., Jump True or Jump False) instruction of an instruction set of an ISA of a computing system.

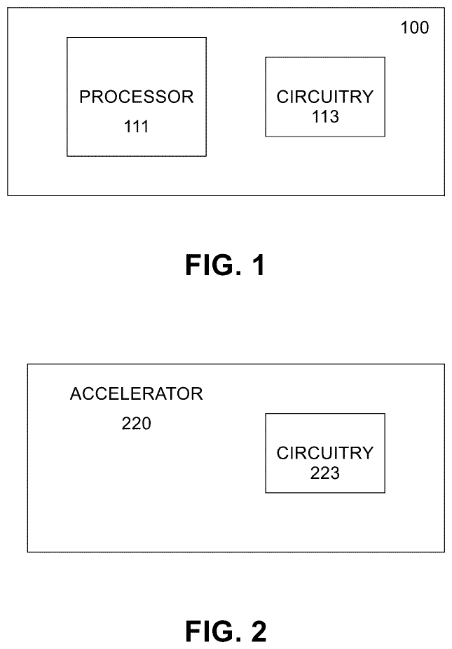

With reference to FIG. 1, an example of a computing system 100 may include a processor 111 to perform operations that include at least at a Jump True operation, and circuitry 113 coupled to processor 111 to, in response to a single processor instruction, cause processor 111 to perform a Jump True operation. For example, each of the source inputs may include one or more input arguments for a subsequent Jump True operation. For example, the various inputs and indications may be included in the instruction itself (e.g., through the opcode, explicit fields of the instruction, pre-determined or implicit inputs/indications, etc.), or the instruction may explicitly or implicitly point to the information that identifies the various inputs and indications. Similarly, destination locations for the one or more results may be explicit operands of the single processor instruction or may be implicit locations (e.g., pre-determined registers or memory locations). For example, in response to the single processor instruction, circuitry 113 may be further configured to cause processor 111 to store the one or more results of the Jump True operation in a location indicated by the single processor instruction.

In one example, in response to the single processor instruction, circuitry 113 may be further configured to cause processor 111 to generate an exception when a value of a source operand is not 0 and not 1, execute a next instruction when the value of the source operand is 0, and jump to a destination indicated by a destination operand when the value of the source operand is 1.

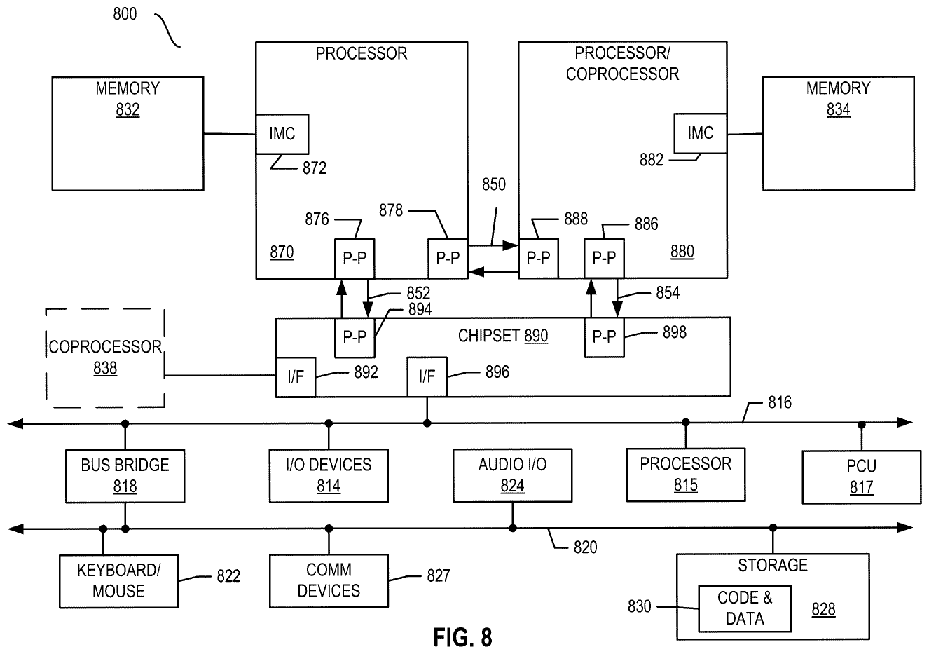

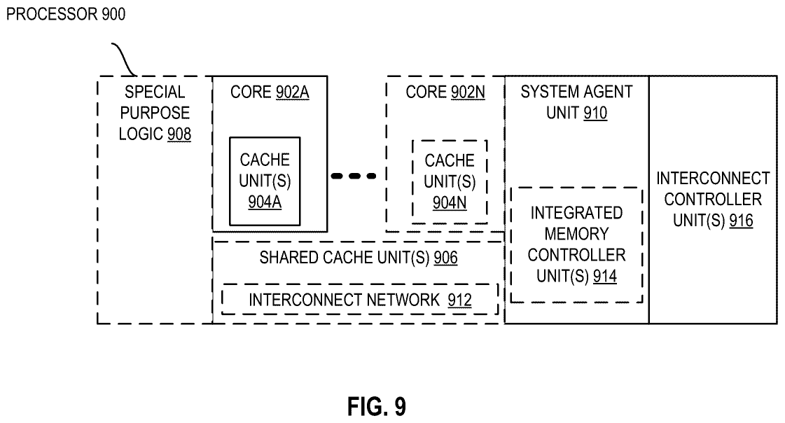

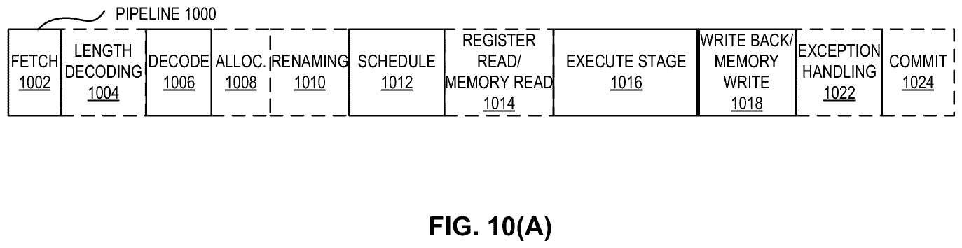

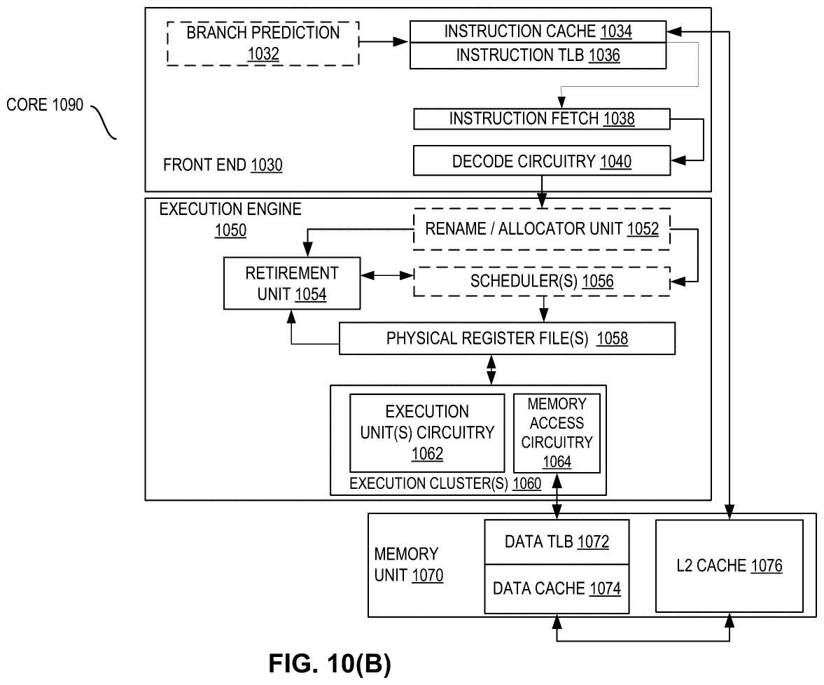

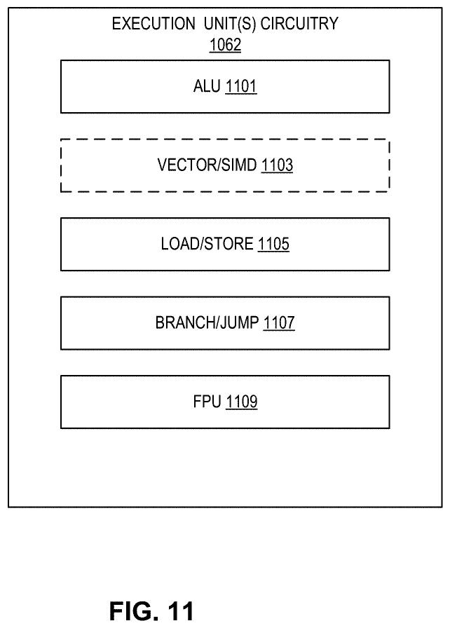

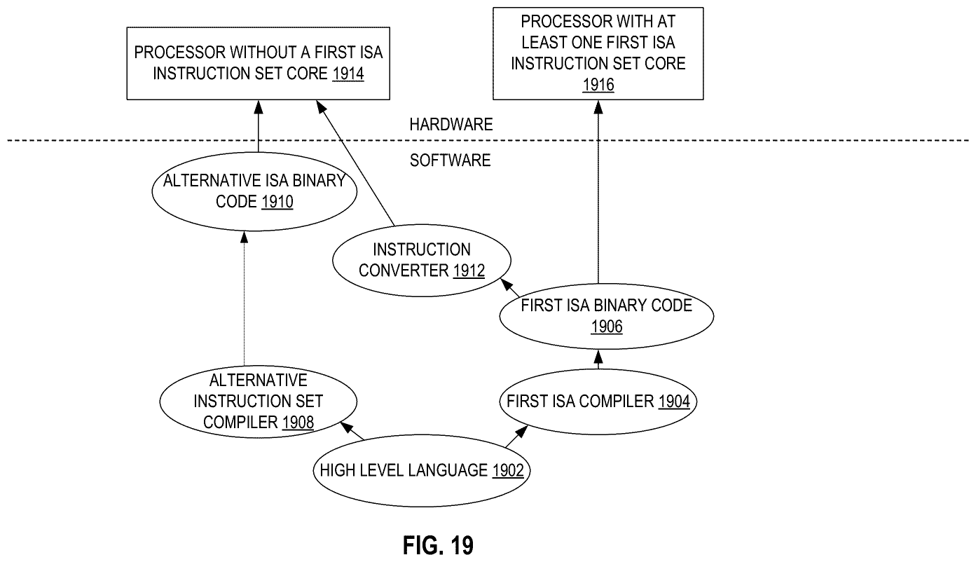

For example, processor 111 may be implemented as any of the processors described below. Circuitry 113 may be incorporated in processor 800, processor 870, processor 815, coprocessor 838, and/or processor/coprocessor 880 (FIG. 8), processor 900 (FIG. 9), core 1090 (FIG. 10B), execution units 1062 (FIGS. 10B and 11), and processor 1916 (FIG. 19).

With reference to FIG. 2, an example of an accelerator 220 may include circuitry 223 to perform operations that include at least at a Jump True operation, and circuitry 223 to cause the accelerator 220 to perform a Jump True operation. For example, each of the source inputs may include one or more input arguments for a subsequent Jump True operation. For example, the various inputs and indications may be included in the circuitry itself (e.g., through the opcode, explicit fields of the operation, pre-determined or implicit inputs/indications, etc.), or the operation may explicitly or implicitly point to the information that identifies the various inputs and indications. Similarly, destination locations for the one or more results may be explicit operands of the operation or may be implicit locations (e.g., pre-determined registers or memory locations). For example, in response to the Jump True operation, circuitry 223 may be further configured to cause accelerator 220 to store the one or more results of the Jump True operation in a location indicated by the Jump true operation.

In one example, in response to the Jump True operation, circuitry 223 may be further configured to cause the accelerator 220 to generate an exception when a value of a source operand is not 0 and not 1, execute a next instruction when the value of the source operand is 0, and jump to a destination indicated by a destination operand when the value of the source operand is 1.

The Jump True operation of the technology described herein prevents control flow misdirection via memory corruption where an adversary may have manipulated Boolean or conditional data type values via memory modification, such as by using a wrong encryption key, “per object” tweak or pointer tag. In computing systems, Boolean data are really stored as bytes, words, or even larger units (that is, not by single bits), where only the least significant bit is used. Thus, the extra bits can be used as canary values to detect memory corruption.

In computing systems supporting multi-key total memory encryption (MKTME), physical data corruption can be detected as a modified bit before a block cipher (implemented a cryptographic process such as advanced encryption standard (AES) XEX tweakable block ciphertext stealing (AES-XTS)) corrupts an entire block of plaintext. When a Boolean or conditional data type is used, this memory corruption is detected by the Jump True instruction described herein.

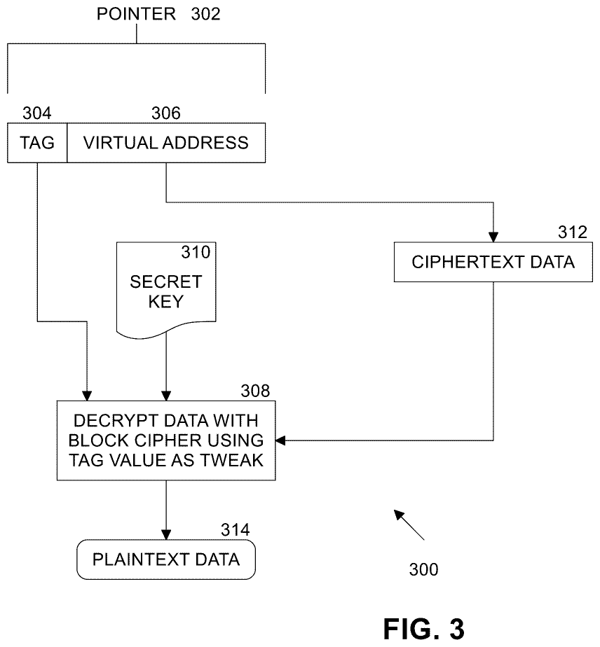

FIG. 3 is a diagram of memory encryption using a tag in one implementation. Performance of encryption on data stored in a memory in a computing system may corrupt other bits if a block cipher is used. For object granular encryption, version tags can be stored in pointers so that data can be encrypted based on the pointer tag value. As illustrated in the arrangement 300 of FIG. 3, tag 304 in pointer 302 may be used as a tweak to decrypt ciphertext data 312 referenced by virtual address 306 (in a memory) of the pointer (e.g., tag 304 can be determined by a memory allocator (not shown in FIG. 3). For example, secret key 310 is used along with tag 304 to decrypt ciphertext data 312 into plaintext data 314 with a block cipher using the tag value as a tweak at operation 308. In an example, pointer 302 is 64 bits, tag 304 is 16 bits, virtual address 306 is 48 bits, and ciphertext data 312 and plaintext data 314 are each 64 bits. In this arrangement, accessing a memory object (e.g., ciphertext data 312) with an incorrect tag will result in data corruption. For example, if an adjacent memory object allocated with a tag value of 2 is overwritten due to a buffer overflow from a memory object with a tag value of 1, future read attempts for the data with tag value of 2 will encounter corrupted data. Other embodiments may use other modes of encryption (for example, a stream cipher, counter mode, etc.) or other encryption algorithms, bit scrambling algorithms or similar processing.

Cryptographic pointer encodings can also be used to change the data encryption depending on locations of objects in memory, size and version. Additionally, accidental corruption of Boolean and conditional data types may be detected even without memory encryption. For example, when a buggy program overwrites memory regions that don't belong to the program, this may cause corruption of conditional variables in the modified memory regions.

As described herein detecting these corrupted bits in memory data of Boolean and conditional data types may be performed by the Jump True instruction, which is a type of compare-jump instruction that triggers an exception when other bits in the source operand are set (e.g., a Boolean value is not 1 or 0). For example, the x86 instruction set architecture (ISA), commercially available from Intel Corporation, includes a type of jump instruction that directly inspects a source operand (e.g., an RCX register (scratch register)) to determine the jump direction based on whether the value of source operand is 0 or 1. Extending this concept, a Jump True instruction is defined herein to check the format and setting of a Boolean value or conditional value in a source operand.

There are, depending on the data type, sometimes unused bits. A Boolean data type takes on the value of only 0 or 1, which can be represented by a single bit, but the Boolean data type is typically comprised of a multi-bit underlying data structure (e.g., a byte). The unused data bits appear in a wide variety of structures often due to alignment needs of the underlying computer architecture (such as aligning a 16-bit variable so it becomes 32 bits, with 16 unused bits). The scrambling of these unused bits (due to memory corruption, corruption of ciphertext in the case of encrypted memory, using the wrong decryption key or tweak/tag, etc.) results in corruption of these unused bits which can be used for detecting memory corruption.

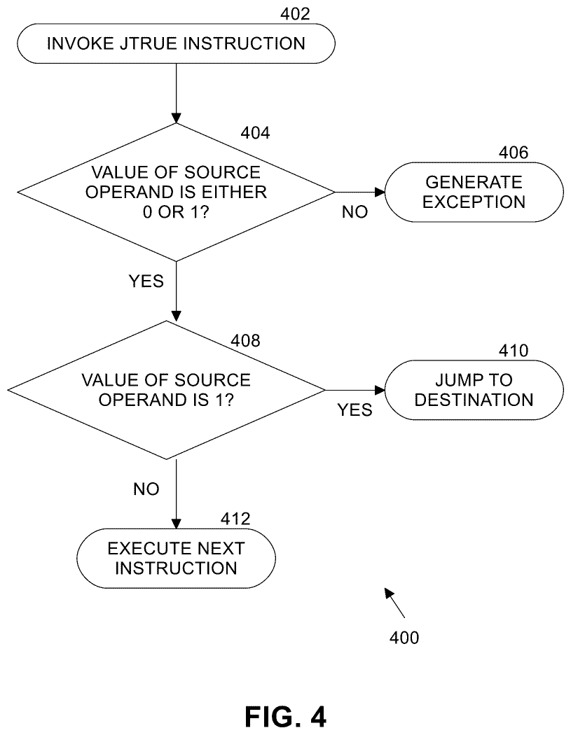

FIG. 4 is a flow diagram of a method 400 to process a Jump True instruction in one implementation. At block 402, a Jump True (JTRUE) instruction is invoked (for example, by processor 111 and/or circuitry 113 of computing system 100 or circuitry 223 of accelerator 220). At block 404, computing system 100 or accelerator 220 determines if a value of a source operand is either a 0 or a 1. In one implementation, the source operand specifies a register operand storing a Boolean data value or a conditional data value and a destination operand specifies a destination of a branch for transferring program control. The source operand may be either a predetermined fixed register (such as RCX) or a selectable register based on the Jump True instruction encoding. If the value of the source operand is not a 0 or 1 (that is, the unused bits of the Boolean data type are not all 0), then in one implementation an exception is generated at block 406 and processing of a program containing the JTRUE instruction is halted. In other implementations, a fault may be generated or an error may be logged. Thus, if the data value referenced by the source operand has one or more bits set other than the least significant bit, it is inferred that memory corruption of the data value has occurred and the error is detected. If the data value referenced by the source operand is a 0 or a 1 at block 404, at block 406 computing system 100 or accelerator 220 determines if the data value referenced by the source operand is a 1. If so, program control jumps to a branch destination specified by the destination operand. If not, program control continues with executing the next instruction at block 412.

Use of the JTRUE instruction may result in more efficient code generated by a compiler for strictly checking Boolean conditions. Consider the following code example in Table 1.

```
TABLE 1
-------------------------------------------------------------------------
#include <stdbool.h>
int f(bool b) {
  if (b) {
    return 1;
  } else {
    return 0;
  }
}
// prior compiler approaches would not catch memory corruption of b. Use of the JTRUE
instruction would // catch memory corruption of b.
int g(int b) {
  if (b) { // since b is not a bool type, the compiler does not apply strict bool checks.
    return 1;
  } else {
    return 0;
  }
}
// prior compiler approaches would not correctly handle the programming error of declaring b as
an integer.
int main( ) {
  f(false);
  f(5); // This will trigger the strict bool checks.
  g(false);
  g(5); // This will be accepted even though it is not a valid bool value, since g is not declared as
accepting a bool.
  return 0;
}
-------------------------------------------------------------------------
```

In the absence of the JTRUE instruction, in one example a compiler would generate the following code shown in Table 2 for the function “f” when strict bool checks are enabled. The underlined instruction sequence would be replaced by a JTRUE instruction, thereby resulting in less code being produced by the compiler (one instruction compared to eight instructions in this example).

TABLE 2
------------------------------------------------------------------------
000000000002cd30 <f>:

| | | | |
|---|---|---|---|
| 2cd30: | 55 | push | %rbp |
| 2cd31: | 48 89 e5 | mov | %rsp,%rbp |
| 2cd34: | 48 83 ec 20 | sub | $0x20,%rsp |
| 2cd38: | 40 88 f8 | mov | %dil,%al |
| 2cd3b: | 24 01 | and | $0x1,%al |
| 2cd3d: | 88 45 fb | mov | %al,−0x5(%rbp) |
| 2cd40: | 8a 45 fb | mov | −0x5(%rbp),%al |
| 2cd43: | 88 45 ef | mov | %al,−0x11(%rbp) |
| 2cd46: | 0f b6 c8 | movzbl | %al,%ecx |
| 2cd49: | 48 89 4d f0 | mov | %rcx,−0x10(%rbp) |
| 2cd4d: | 3c 01 | cmp | $0x1,%al // Compare bool against the upper limit of the |

valid bool values.

| | | | |
|---|---|---|---|
| 2cd4f: | 0f 86 10 00 00 00 | jbe | 2cd65 <f+0x35> // If the bool has a valid format, then |

jump ahead.

| | | | |
|---|---|---|---|
| 2cd55: | 48 8b 75 f0 | mov | −0x10(%rbp),%rsi |
| 2cd59: | 48 8d 3d 10 6e 01 00 | lea | 0x16e10(%rip),%rdi |

# 43b70 <_ZN7__ubsan14TypeCheckKindsE+0x60>

| | | | |
|---|---|---|---|
| 2cd60: | e8 cb d9 ff ff | callq | 2a730 <__ubsan_handle_load_invalid_value> // The |

bool did not have a valid format, so call an error handler.

| | | | |
|---|---|---|---|
| 2cd65: | 8a 45 ef | mov | −0x11(%rbp),%al |
| 2cd68: | a8 01 | test | $0x1,%al // Check whether the bool is set to true. |
| 2cd6a: | 0f 84 0c 00 00 00 | je | 2cd7c <f+0x4c> // If so, jump to the “if” block. |

Otherwise, fall through to the else block.

| | | | |
|---|---|---|---|
| 2cd70: | c7 45 fc 01 00 00 00 | movl | $0x1,−0x4(%rbp) |
| 2cd77: | e9 07 00 00 00 | jmpq | 2cd83 <f+0x53> |
| 2cd7c: | c7 45 fc 00 00 00 00 | movl | $0x0,−0x4(%rbp) |
| 2cd83: | 8b 45 fc | mov | −0x4(%rbp),%eax |
| 2cd86: | 48 83 c4 20 | add | $0x20,%rsp |
| 2cd8a: | 5d | pop | %rbp |
| 2cd8b: | c3 | retq | |
| 2cd8c: | 0f 1f 40 00 | nopl | 0x0(%rax) |

------------------------------------------------------------------------

For case statements and other conditionals, the instruction generating the exception at block 406 can also have a mask (e.g., check seven upper bits of a byte (of the data value referenced by the source operand) and verify zero or cause an exception) or range that is considered valid.

The compiler may be configurable to only apply strict checks in particular circumstances, e.g., where a Boolean data type has been used by the program developer as a hint that only the values 0 or 1 will be assigned to the variable. This allows legacy code that expects to be able to treat all non-zero values as “true” to continue to operate while still performing strict checks on a subset of code. Another compiler option could be to enforce strict checks on all conditionals to further harden the program potentially at the cost of requiring code changes.

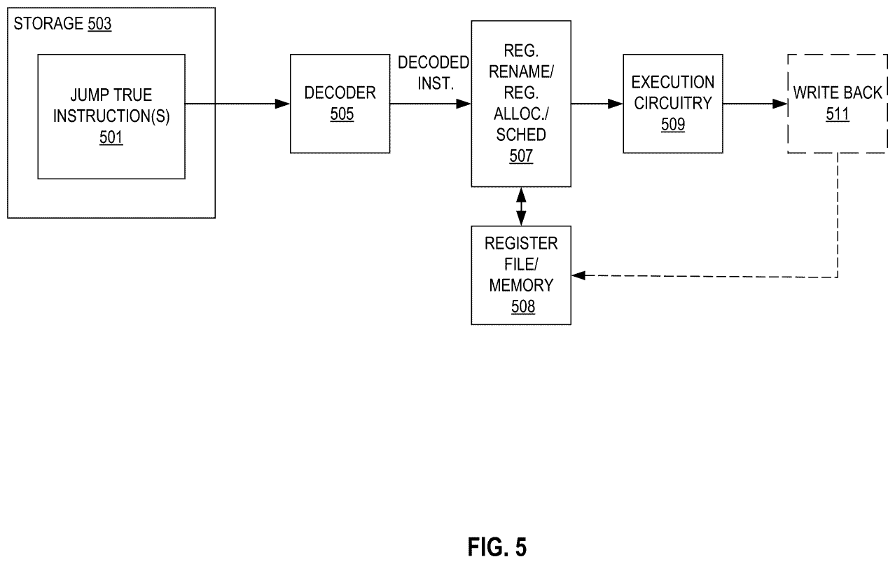

FIG. 5 illustrates examples of computing hardware to process an instruction. The instruction may be a Jump True (JTRUE) instruction. As illustrated, storage 503 stores a JTRUE instruction 501 to be executed.

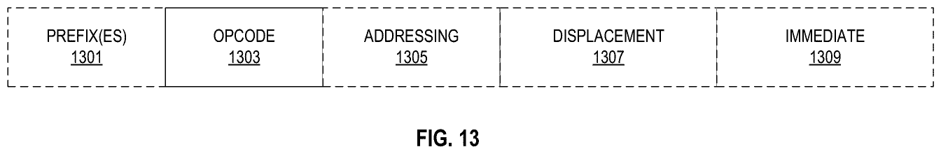

The JTRUE instruction 501 is received by decoder circuitry 505. For example, the decoder circuitry 505 receives this instruction from fetch circuitry (not shown). The instruction may be in any suitable format, such as that describe with reference to FIG. 13 below. In an example, the instruction includes fields for an opcode, a source identifier (e.g., a source operand), and a destination identifier. In some examples, the source and destination are registers, and in other examples, one or more are memory locations. In some examples, the source may be an immediate operand.

More detailed examples of at least one instruction format for the instruction will be detailed later. The decoder circuitry 505 decodes the instruction into one or more operations. In some examples, this decoding includes generating a plurality of micro-operations to be performed by execution circuitry (such as execution circuitry 509). The decoder circuitry 505 also decodes instruction prefixes.

In some examples, register renaming, register allocation, and/or scheduling circuitry 507 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 508 store data as operands of the instruction to be operated on by execution circuitry 509. Exemplary register types include packed data registers, general purpose registers (GPRs), and floating-point registers.

Execution circuitry 509 executes the decoded instruction. Exemplary detailed execution circuitry includes execution cluster(s) 1060 shown in FIG. 10B, etc. The execution of the decoded instruction causes the execution circuitry 509 to perform the Jump True operation on an identified source operand to return a result and store the result into an identified destination operand.

In some examples, a field for an identifier of the source operand may be to identify a vector register. Alternatively, the field for the identifier of the source operand may be to identify a memory location. In some examples, retirement/write back circuitry 511 architecturally commits the destination register into the registers or memory 508 and retires the instruction.

An example of a format for a JTRUE instruction is OPCODE DST, SRC. In some examples, OPCODE is the opcode mnemonic of the instruction. DST is a field for the destination operand, such as packed data register or memory. SRC is a field for the source operand, such as packed data registers and/or memory.

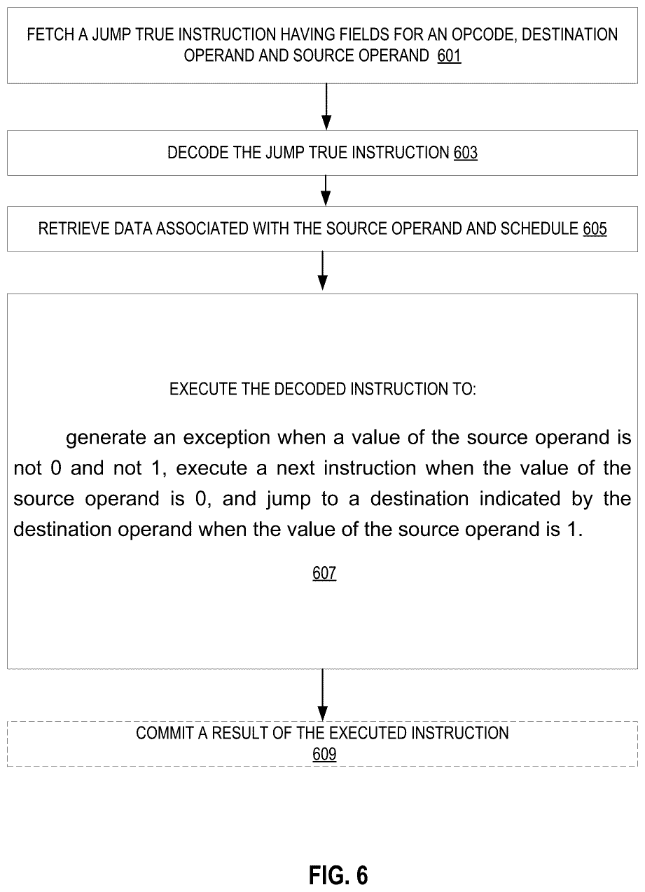

FIG. 6 is a flow diagram of a method 600 to process a Jump True instruction in one implementation. For example, a processor core as shown in FIG. 10B, a pipeline as detailed below, etc., performs this method.

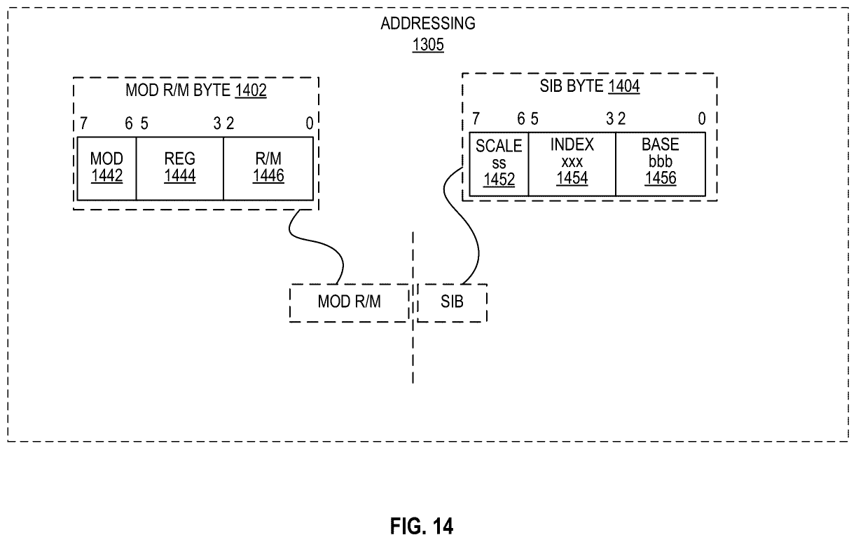

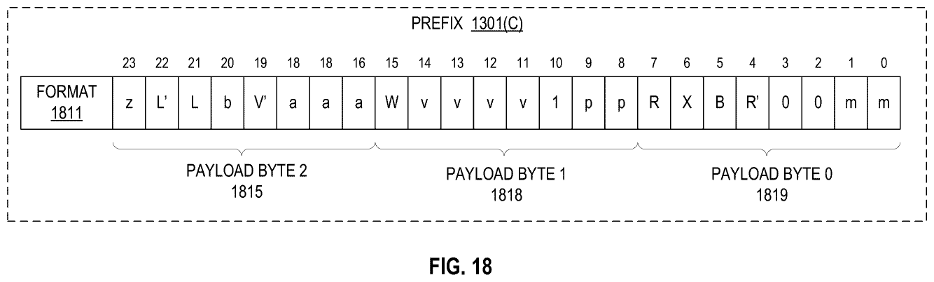

At 601, an instance of a single instruction is fetched. For example, a JTRUE instruction is fetched. The instruction includes fields for an opcode, a destination operand, and a source operand. In some examples, a second prefix may be used (e.g., second prefix 1301(B); FIGS. 16A-B) with no writemask. In some examples, a third prefix may be used (e.g., third prefix 1301(C); FIG. 18) and the instruction further includes a field for a writemask (e.g., {k1}). In some examples the destination operand may be indicated by REG 1444 (FIG. 14). In some examples, the source operand may be indicated by vvvv from payload byte 1717 (FIG. 18), byte 1 1605 (FIG. 16A), or byte 2 1617 (FIG. 16B). In some examples, the source operand may be indicated by at least R/M 1446 (FIG. 14). In some examples, the instruction is fetched from an instruction cache. The opcode indicates the JTRUE operation to perform.

The fetched instruction is decoded at 603. For example, the fetched JTRUE instruction is decoded by decoder circuitry, such as decoder circuitry 505 or decode circuitry 1040 detailed herein.

Data values associated with the source operand of the decoded instruction are retrieved when the decoded instruction is scheduled at 605. For example, when the source operand is a memory operand, the data from the indicated memory location is retrieved.

At 607, the decoded instruction is executed by execution circuitry (hardware) such as execution circuitry 509 shown in FIG. 5, or execution cluster(s) 1060 shown in FIG. 10B. In some examples, the instruction is committed or retired at 609.

For the JTRUE instruction, the execution will cause execution circuitry to perform the operations described in connection with FIG. 4. At 607, the execution circuitry may execute the decoded instruction to generate an exception when a value of the source operand is not 0 and not 1, execute a next instruction when the value of the source operand is 0, and jump to a destination indicated by the destination operand when the value of the source operand is 1.

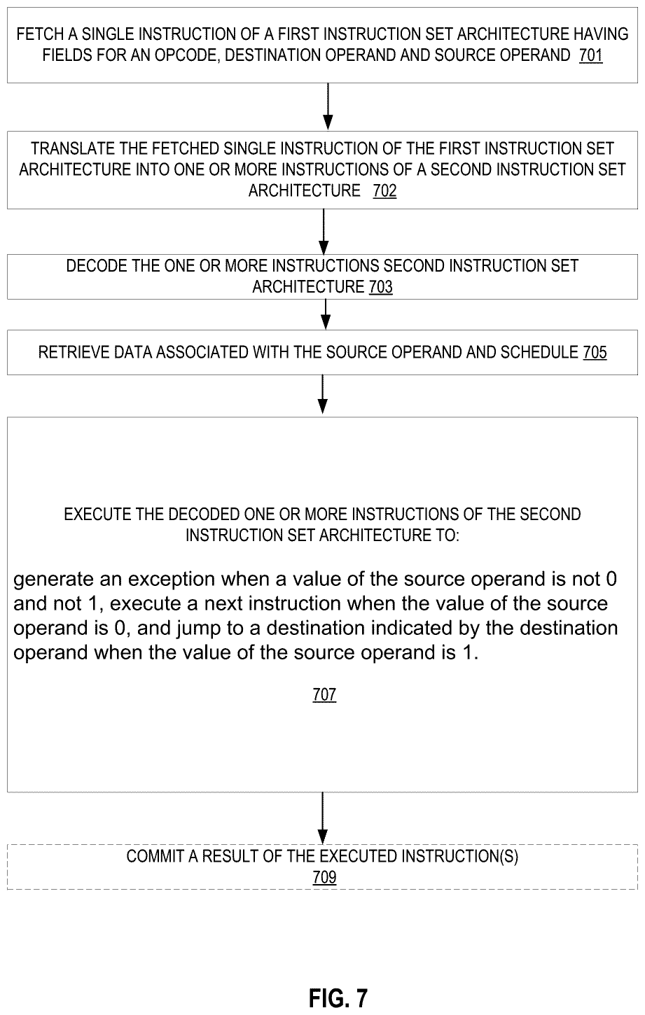

FIG. 7 is a flow diagram of another method 700 to process a Jump True instruction in one implementation. FIG. 7 illustrates an example of method 700 to process a JTRUE instruction using emulation or binary translation. For example, a processor core as shown in FIG. 10B, a pipeline and/or emulation/translation layer perform aspects of this method.

An instance of a single instruction of a first instruction set architecture is fetched at 701. For example, a JTRUE instruction is fetched. The instance of the single instruction of the first instruction set architecture including fields for an opcode, a destination operand and a source operand. In some examples, a second prefix may be used (e.g., second prefix 1301(B); FIGS. 16A-B) with no writemask. In some examples, a third prefix may be used (e.g., third prefix 1301(C); FIG. 18) and the instruction further includes a field for a writemask (e.g., {k1}). In some examples the destination operand may be indicated by REG 1444 (FIG. 14). In some examples, the source operand may be indicated by vvvv from payload byte 1717 (FIG. 18), byte 1 1605 (FIG. 16A), or byte 2 1617 (FIG. 16B). In some examples, the source operand may be indicated by at least R/M 1446 (FIG. 14). In some examples, the instruction is fetched from an instruction cache. The opcode indicates at least one JTRUE operation to perform.

The fetched single instruction of the first instruction set architecture is translated into one or more instructions of a second instruction set architecture at 702. This translation is performed by a translation and/or emulation layer of software in some examples. In some examples, this translation is performed by an instruction converter 1812 as shown in FIG. 18. In some examples, the translation is performed by hardware translation circuitry.

The one or more translated instructions of the second instruction set architecture are decoded at 703. For example, the translated instructions are decoded by decoder circuitry such as decoder circuitry 505 or decode circuitry 1040 detailed herein. In some examples, the operations of translation and decoding at 702 and 703 are merged.

Data values associated with the source operand of the decoded one or more instructions of the second instruction set architecture are retrieved and the one or more instructions are scheduled at 705. For example, when the source operand is a memory operand, the data from the indicated memory location is retrieved.

At 707, the decoded instruction(s) of the second instruction set architecture is/are executed by execution circuitry (hardware) such as execution circuitry 509 shown in FIG. 5, or execution cluster(s) 1060 shown in FIG. 10B, to perform the operation(s) indicated by the opcode of the single instruction of the first instruction set architecture. In some examples, the instruction is committed or retired at 709.

For the JTRUE instruction, the execution will cause execution circuitry to perform the operations described in connection with FIG. 4. At 707, the execution circuitry may execute the decoded instruction to generate an exception when a value of the source operand is not 0 and not 1, execute a next instruction when the value of the source operand is 0, and jump to a destination indicated by the destination operand when the value of the source operand is 1. In other implementations, the significance of the value of the source operand may be changed such that a next instruction is executed when the value of the source operand is 1, and a jump to a destination indicated by the destination operand is performed when the value of the source operand is 0. In another implementation, the functionality of the JTRUE instruction may be performed instead by a JFALSE instruction that jumps if a boolean input value is false (0) and executes the next instruction if true (1).

Besides conditional data types, other data types may be expanded in size so execution of the JTRUE instruction may detect memory corruption. For example, 32-bit variables may be extended to 64 bits by the compiler while identifying the data type as an integrity protected 32-bit value, where the additional (e.g., higher or most significant bits (MSB)) 32 bits are used as a canary value to detect memory corruption by using the JTRUE instruction. Similarly, a 16-bit integer can be expanded into a 32-bit value where the upper bits operate as a canary value to detect corruption by using the JTRUE instruction. Other instructions operating on these meta types may also then verify the canary portion in parallel with operating on the 32 data bits (e.g., Compare, Add, Subtract, multiply, etc.). For example, if the canary portion is not 0 (other fixed expected value that may be used as long as the computing hardware knows what value these unused bits are supposed to be in the case of no corruption), then it may be assumed that a memory corruption of the data value has occurred.

Some processors have alignment requirements where data types are expanded to fit the architecture word size. The technology described herein provides an optimization because the processor always accesses the same word size (e.g. 32 bits or 64 bits). This can improve performance (e.g., for 64-bit reduced instruction set computing (RISC) processors.) For example, the processor may always load 64 bits into 64-bit registers. The program may only need 32 bits and declare the data type as a UINT32. The processor may be made aware that the expected data type is UINT32, and the remaining 32 bits are used as a canary. Similarly to the JTRUE instruction described herein, some instructions (such as Add32, Sub32, Mul32, Compare32 . . . ) may be used exclusively for UINT32 data types and will test the upper 32 bits as a canary and trigger an exception if the canary value is corrupted.

An alternative to a canary may be if the data itself is not encrypted, to insert or append an authentication code. In some cases, specifically if the value to be authenticated fits in the same data range as linear/virtual addresses, then pointer authentication instructions may be reused for this purpose by pretending that the data value is a pointer. For example, if the data is 32 bits, and the machine supports 39-bit addresses with an authentication code in a portion of the remaining 25 bits in the overall 64-bit pointer storage, then the data fits within the same space that the address would have required (with some bits left over in this example), and hence the authentication code also fits in a 64-bit overall storage allocation for the value. However, a dedicated key or tweak input may be used to help avoid this being used to forge pointers from arbitrary data values. If instead the same key and tweak were used for both pointers and data values, then malicious code may pretend to be generating an authentication code for non-pointer data, which is often less security-critical than pointers, but the malicious code may then supply the authenticated data to be used as a pointer with a value chosen by the malicious code. The authentication code would then be accepted as valid for a pointer, even though the pointer has been forged.

In an alternative, programs may selectively instrument operations on variables that are identified as sensitive or, conservatively, all variables. If the main perceived threat is that data may be corrupted in memory rather than in registers, then the program may explicitly authenticate variable values as they are sent to and from memory. For example, if a particular variable stores a numeric user ID that is used to control access to various resources, an authentication code may be stored for that user ID when the user ID is stored to memory and the authentication code is validated when the user ID is loaded back from memory.

The format/integrity checks may be extracted into a separate instruction that generates an exception in the case of invalid data formatting while relying on existing jump types for determining control flow based on properly formatted values. For example, the format checks may be combined with the memory load to minimize code footprint increases.

In one scenario, more sophisticated analysis may be performed by the compiler on variables to determine if the variables were corrupted, for example, by defining instructions that verify that data types remain with certain ranges of values (for example, to avoid integer overflows). In parallel to performing the data operation, instructions may also verify the variables operate within their expected ranges, where values occurring outside the expected ranges will cause exceptions.

Other embodiments may log an error or use processor trace (PT) or similar extensions to log the use of a variable that is not formatted as expected. For example, the computing system may add to the log on the conditional trace that a Boolean data type had a value other than 0 or 1. A trace processor may subsequently detect that event and perform some response, such as terminating the program.

Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous. Though the exemplary system 800 is shown to have two processors, the system may have three or more processors, or may be a single processor system.

Processors 870 and 880 are shown including integrated memory controller (IMC) circuitry 872 and 882, respectively. Processor 870 also includes as part of its interconnect controller point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via an interface 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be one or more non-transitory machine-readable storage media as described below, such as a disk drive or other mass storage device which may include instructions/code and data 830. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 9 illustrates a block diagram of an example processor 900 that may have more than one core and an integrated memory controller. The solid lined boxes illustrate a processor 900 with a single core 902A, a system agent unit circuitry 910, a set of one or more interconnect controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interconnect controller units circuitry 916. Note that the processor 900 may be one of the processors 970 or 980, or co-processor 938 or 915 of FIG. 9.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902(A)-(N).

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

Exemplary Core Architectures—In-Order and Out-of-Order Core Block Diagram.

FIG. 10A is a block diagram illustrating both an exemplary in-order pipeline and an exemplary register renaming, out-of-order issue/execution pipeline according to examples. FIG. is a block diagram illustrating both an exemplary example of an in-order architecture core and an exemplary register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

Exemplary Execution Unit(s) Circuitry.

FIG. 11 illustrates examples of execution unit(s) circuitry, such as execution unit(s) circuitry 1062 of FIG. 10B. As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1162 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Exemplary Register Architecture

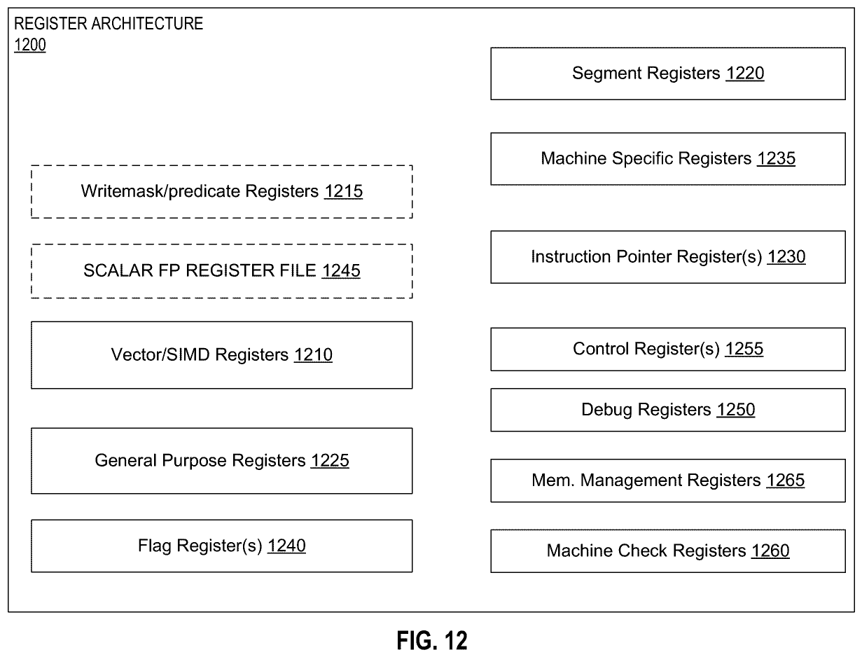

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMIM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMIM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1200 may, for example, be used in register file/memory 408, or physical register file(s) circuitry 1058.

Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

Exemplary Instruction Formats.

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

FIG. 14 illustrates examples of an instruction format. As illustrated, an instruction may include multiple components including, but not limited to, one or more fields for: one or more prefixes 1301, an opcode 1303, addressing information 1305 (e.g., register identifiers, memory addressing information, etc.), a displacement value 1307, and/or an immediate value 1309. Note that some instructions utilize some or all of the fields of the format whereas others may only use the field for the opcode 1303. In some examples, the order illustrated is the order in which these fields are to be encoded, however, it should be appreciated that in other examples these fields may be encoded in a different order, combined, etc.

The prefix(es) field(s) 1301, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1303 is used to at least partially define the operation to be performed upon a decoding of the instruction. In some examples, a primary opcode encoded in the opcode field 1303 is one, two, or three bytes in length. In other examples, a primary opcode can be a different length. An additional 3-bit opcode field is sometimes encoded in another field.

The addressing field 1305 is used to address one or more operands of the instruction, such as a location in memory or one or more registers. FIG. 14 illustrates examples of the addressing field 1305. In this illustration, an optional ModR/M byte 1402 and an optional Scale, Index, Base (SIB) byte 1404 are shown. The ModR/M byte 1402 and the SIB byte 1404 are used to encode up to two operands of an instruction, each of which is a direct register or effective memory address. Note that each of these fields are optional in that not all instructions include one or more of these fields. The MOD R/M byte 1402 includes a MOD field 1442, a register (reg) field 1444, and R/M field 1446.

The content of the MOD field 1442 distinguishes between memory access and non-memory access modes. In some examples, when the MOD field 1442 has a binary value of 11 (11b), a register-direct addressing mode is utilized, and otherwise register-indirect addressing is used.

The register field 1444 may encode either the destination register operand or a source register operand or may encode an opcode extension and not be used to encode any instruction operand. The content of register index field 1444, directly or through address generation, specifies the locations of a source or destination operand (either in a register or in memory). In some examples, the register field 1444 is supplemented with an additional bit from a prefix (e.g., prefix 1301) to allow for greater addressing.

The R/M field 1446 may be used to encode an instruction operand that references a memory address or may be used to encode either the destination register operand or a source register operand. Note the R/M field 1446 may be combined with the MOD field 1442 to dictate an addressing mode in some examples.

The SIB byte 1404 includes a scale field 1452, an index field 1454, and a base field 1456 to be used in the generation of an address. The scale field 1452 indicates scaling factor. The index field 1454 specifies an index register to use. In some examples, the index field 1454 is supplemented with an additional bit from a prefix (e.g., prefix 1301) to allow for greater addressing. The base field 1456 specifies a base register to use. In some examples, the base field 1456 is supplemented with an additional bit from a prefix (e.g., prefix 1301) to allow for greater addressing. In practice, the content of the scale field 1452 allows for the scaling of the content of the index field 1454 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, a displacement 1307 provides this value. Additionally, in some examples, a displacement factor usage is encoded in the MOD field of the addressing field 1305 that indicates a compressed displacement scheme for which a displacement value is calculated and stored in the displacement field 1307.

In some examples, an immediate field 1309 specifies an immediate value for the instruction. An immediate value may be encoded as a 1-byte value, a 2-byte value, a 4-byte value, etc.

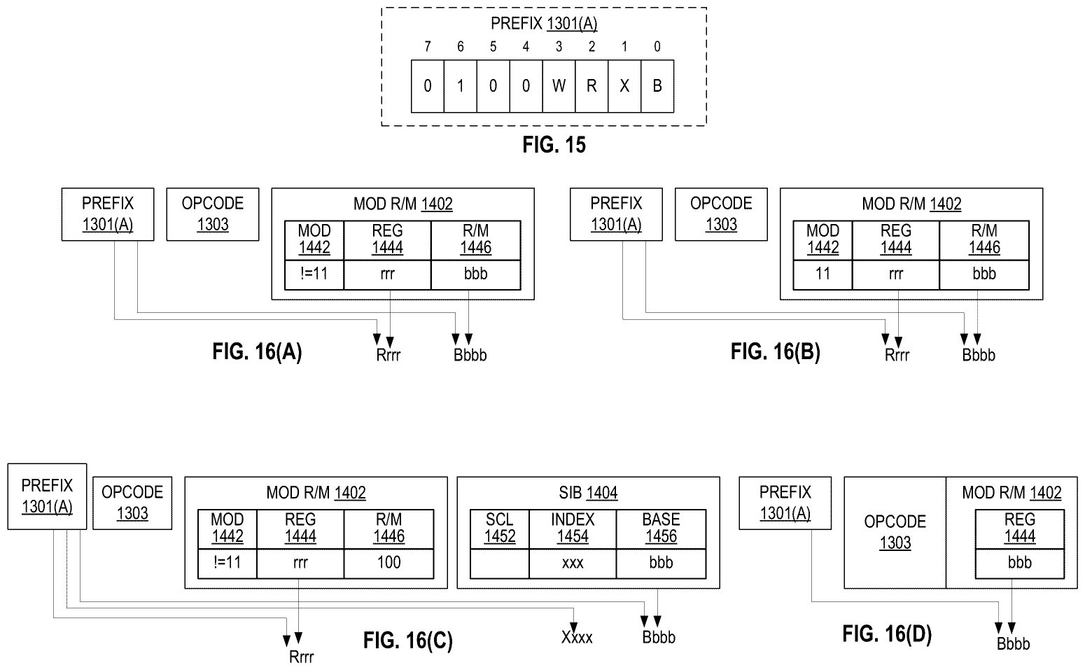

FIG. 15 illustrates examples of a first prefix 1301(A). In some examples, the first prefix 1301(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1301(A) may specify up to three registers using 3-bit fields depending on the format: 1) using the reg field 1444 and the R/M field 1446 of the Mod R/M byte 1402; 2) using the Mod R/M byte 1402 with the SIB byte 1404 including using the reg field 1444 and the base field 1456 and index field 1454; or 3) using the register field of an opcode.

In the first prefix 1301(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1344 and MOD R/M R/M field 1346 alone can each only address 8 registers.

In the first prefix 1301(A), bit position 2 (R) may be an extension of the MOD R/M reg field 1444 and may be used to modify the ModR/M reg field 1444 when that field encodes a general-purpose register, a 64-bit packed data register (e.g., a SSE register), or a control or debug register. R is ignored when Mod R/M byte 1402 specifies other registers or defines an extended opcode.

Bit position 1 (X) may modify the SIB byte index field 1454.

Bit position 0 (B) may modify the base in the Mod R/M R/M field 1446 or the SIB byte base field 1456; or it may modify the opcode register field used for accessing general purpose registers (e.g., general purpose registers 1225).

FIGS. 16A-D illustrate examples of how the R, X, and B fields of the first prefix 1301(A) are used. FIG. 16A illustrates R and B from the first prefix 1301(A) being used to extend the reg field 1344 and R/M field 1346 of the MOD R/M byte 1302 when the SIB byte 13 04 is not used for memory addressing. FIG. 16B illustrates R and B from the first prefix 1301(A) being used to extend the reg field 1344 and R/M field 1346 of the MOD R/M byte 1302 when the SIB byte 13 04 is not used (register-register addressing). FIG. 16C illustrates R, X, and B from the first prefix 1301(A) being used to extend the reg field 1344 of the MOD R/M byte 1302 and the index field 1354 and base field 1356 when the SIB byte 13 04 being used for memory addressing. FIG. 16D illustrates B from the first prefix 1301(A) being used to extend the reg field 1344 of the MOD R/M byte 1302 when a register is encoded in the opcode 1303.

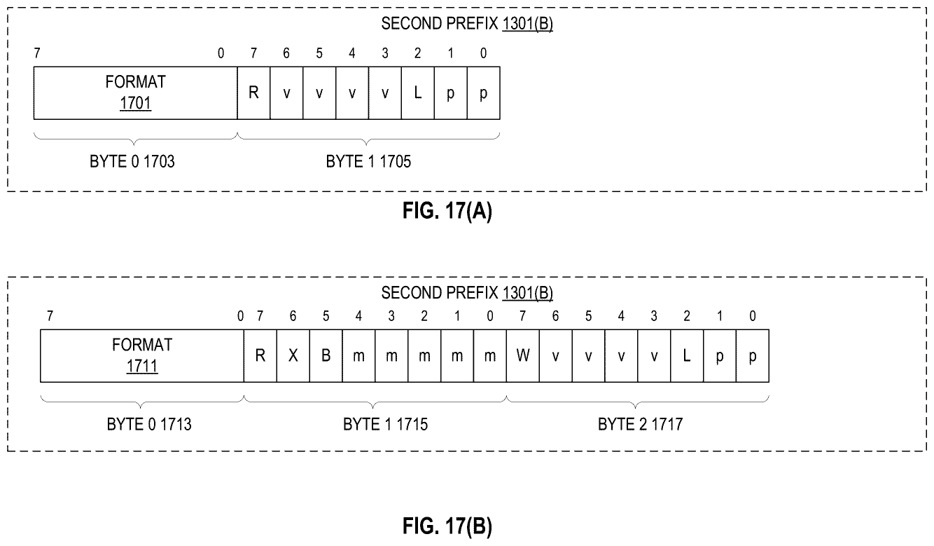

FIGS. 17A-B illustrate examples of a second prefix 1301(B). In some examples, the second prefix 1301(B) is an example of a VEX prefix. The second prefix 1301(B) encoding allows instructions to have more than two operands, and allows SIMD vector registers (e.g., vector/SIMD registers 1210) to be longer than 64-bits (e.g., 128-bit and 256-bit). The use of the second prefix 1301(B) provides for three-operand (or more) syntax. For example, previous two-operand instructions performed operations such as A=A+B, which overwrites a source operand. The use of the second prefix 1301(B) enables operands to perform nondestructive operations such as A=B+C.

In some examples, the second prefix 1301(B) comes in two forms—a two-byte form and a three-byte form. The two-byte second prefix 1301(B) is used mainly for 128-bit, scalar, and some 256-bit instructions; while the three-byte second prefix 1301(B) provides a compact replacement of the first prefix 1301(A) and 3-byte opcode instructions.

FIG. 17A illustrates examples of a two-byte form of the second prefix 1301(B). In one example, a format field 1701 (byte 0 1703) contains the value C5H. In one example, byte 1 1705 includes a “R” value in bit[7]. This value is the complement of the “R” value of the first prefix 1301(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1446 to encode the instruction operand that references a memory address or encode either the destination register operand or a source register operand.

Instructions that use this prefix may use the Mod R/M reg field 1444 to encode either the destination register operand or a source register operand, be treated as an opcode extension and not used to encode any instruction operand.

For instruction syntax that support four operands, vvvv, the Mod R/M R/M field 1446 and the Mod R/M reg field 1444 encode three of the four operands. Bits[7:4] of the immediate 1309 are then used to encode the third source register operand.

FIG. 17B illustrates examples of a three-byte form of the second prefix 1301(B). In one example, a format field 1611 (byte 0 1613) contains the value C4H. Byte 1 1715 includes in bits[7:5] “R,” “X,” and “B” which are the complements of the same values of the first prefix 1301(A). Bits[4:0] of byte 1 1715 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1717 is used similar to W of the first prefix 1301(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the Mod R/M R/M field 1446 to encode the instruction operand that references a memory address or encode either the destination register operand or a source register operand.

Instructions that use this prefix may use the Mod R/M reg field 1444 to encode either the destination register operand or a source register operand, be treated as an opcode extension and not used to encode any instruction operand.

For instruction syntax that support four operands, vvvv, the Mod R/M R/M field 1446, and the Mod R/M reg field 1444 encode three of the four operands. Bits[7:4] of the immediate 1309 are then used to encode the third source register operand.

FIG. 18 illustrates examples of a third prefix 1301(C). In some examples, the first prefix 1301(A) is an example of an EVEX prefix. The third prefix 1301(C) is a four-byte prefix.

The third prefix 1301(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 12) or predication utilize this prefix. Opmask register allow for conditional processing or selection control. Opmask instructions, whose source/destination operands are opmask registers and treat the content of an opmask register as a single value, are encoded using the second prefix 1301(B).

The third prefix 1301(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1301(C) is a format field 1811 that has a value, in one example, of 62H. Subsequent bytes are referred to as payload bytes 1815-1819 and collectively form a 24-bit value of P[23:0] providing specific capability in the form of one or more fields (detailed herein).

In some examples, P[1:0] of payload byte 1819 are identical to the low two mmmmm bits. P[3:2] are reserved in some examples. Bit P[4] (R′) allows access to the high 16 vector register set when combined with P[7] and the ModR/M reg field 1444. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1444 and ModR/M R/M field 1446. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 1301(A) and second prefix 1311(B) and may serve as an opcode extension bit or operand size promotion.

P[18:16] specify the index of a register in the opmask (writemask) registers (e.g., writemask/predicate registers 1215). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary examples of encoding of registers in instructions using the third prefix 1301(C) are detailed in the following tables.

TABLE 11
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 12
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 13
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-k7 | 1^{st} Source |
| {k1] | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 19 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 19 shows a program in a high-level language 1902 may be compiled using a first ISA compiler 1904 to generate first ISA binary code 1906 that may be natively executed by a processor with at least one first instruction set architecture core 1916. The processor with at least one first ISA instruction set architecture core 1916 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1904 represents a compiler that is operable to generate first ISA binary code 1906 (e.g., object code) that can, with or without additional linkage processing, be executed on the processor with at least one first ISA instruction set architecture core 1916. Similarly, FIG. 19 shows the program in the high-level language 1902 may be compiled using an alternative instruction set architecture compiler 1908 to generate alternative instruction set architecture binary code 1910 that may be natively executed by a processor without a first ISA instruction set architecture core 1914. The instruction converter 1912 is used to convert the first ISA binary code 1906 into code that may be natively executed by the processor without a first ISA instruction set architecture core 1914. This converted code is not necessarily to be the same as the alternative instruction set architecture binary code 1910; however, the converted code will accomplish the general operation and be made up of instructions from the alternative instruction set architecture. Thus, the instruction converter 1912 represents software, firmware, hardware, or a combination thereof that, through emulation, simulation or any other process, allows a processor or other electronic device that does not have a first ISA instruction set architecture processor or core to execute the first ISA binary code 1906.

Techniques and architectures for instructions for min-max operations are described herein. In the above description, for purposes of explanation, numerous specific details are set forth in order to provide a thorough understanding of certain examples. It will be apparent, however, to one skilled in the art that certain examples can be practiced without these specific details. In other instances, structures and devices are shown in block diagram form in order to avoid obscuring the description

### Additional Notes and Examples

Example 1 includes an apparatus including decoder circuitry to decode a single instruction, the single instruction to include a field for an decoder circuitry to decode a single instruction, the single instruction to include a field for an identifier of a source operand, a field for an identifier of a destination operand, and a field for an opcode, the opcode to indicate execution circuitry is to perform a conditional jump operation; and execution circuitry to execute the decoded instruction according to the opcode to perform the conditional jump operation to: generate an exception when a value of the source operand is not a first value and not a second value, execute a next instruction when the value of the source operand is the first value, and jump to a destination indicated by the destination operand when the value of the source operand is the second value.

In Example 2, the subject matter of Example 1 may optionally include wherein the field for the identifier of the source operand is to identify a register. In Example 3, the subject matter of Example 1 may optionally include wherein the field for the identifier of the source operand is to identify a memory location. In Example 4, the subject matter of Example 1 may optionally include wherein the source operand is to store a Boolean data type. In Example 5, the subject matter of Example 1 may optionally include wherein the source operand is to store decrypted memory data of the Boolean data type. In Example 6, the subject matter of Example 1 may optionally include wherein the source operand is to store a conditional data type. In Example 7, the subject matter of Example 1 may optionally include wherein when the source operand is to store an integer data type having an upper half and a lower half, the execution circuitry is to execute the decoded instruction according to the opcode to perform the conditional jump operation to generate an exception when a value of the upper half is not the first value. In Example 8, the subject matter of Example 1 may optionally include wherein the conditional jump operation is a Jump True operation and the first value is 0 and the second value is 1. In Example 9, the subject matter of Example 1 may optionally include wherein the conditional jump operation is a Jump False operation and the first value is 1 and the second value is 0.

Example 10 is a method including etching an instruction having fields for an opcode, a destination operand, and a source operand; decoding the instruction according to the opcode; retrieving data associated with the source operand; scheduling execution of the decoded instruction; and executing the decoded instruction to generate an exception when a value of the source operand is not a first value and not a second value, execute a next instruction when the value of the source operand is the first value, and jump to a destination indicated by the destination operand when the value of the source operand is the second value.

In Example 11, the subject matter of Example 10 may optionally include wherein the source operand is to identify a register. In Example 12, the subject matter of Example 10 may optionally include wherein the source operand is to identify a memory location. In Example 13, the subject matter of Example 10 may optionally include wherein the source operand is to store a Boolean data type. In Example 14, the subject matter of Example 13 may optionally include wherein the source operand is to store decrypted memory data of the Boolean data type. In Example 15, the subject matter of Example 10 may optionally include wherein the source operand is to store a conditional data type. In Example 16, the subject matter of Example 10 may optionally include wherein when the source operand is to store an integer data type having an upper half and a lower half, further comprising executing the decoded instruction according to the opcode to generate an exception when a value of the upper half is not the first value. In Example 17, the subject matter of Example 10 may optionally include wherein the instruction is a Jump True instruction and the first value is 0 and the second value is 1. In Example 18, the subject matter of Example 10 may optionally include wherein the instruction is a Jump False instruction and the first value is 1 and the second value is 0.

Example 19 is an apparatus including a processor coupled to a memory to perform a conditional jump operation; and circuitry coupled to the processor and the memory to, in response to a single processor instruction, cause the processor to perform the conditional operation to generate an exception when a value of a source operand is not a first value and not a second value, execute a next instruction when the value of the source operand is the first value, and jump to a destination indicated by a destination operand when the value of the source operand is the second value.

In Example 20, the subject matter of Example 19 may optionally include wherein the source operand is to store a Boolean data type. In Example 21, the subject matter of Example 20 may optionally include wherein the source operand is to store decrypted memory data of the Boolean data type. In Example 22, the subject matter of Example 19 may optionally include wherein the conditional jump operation is a Jump True operation and the first value is 0 and the second value is 1. In Example 23, the subject matter of Example 19 may optionally include wherein the conditional jump operation is a Jump False operation and the first value is 1 and the second value is 0.

Example 24 is an apparatus operative to perform the method of any one of Examples 10 to 18. Example 25 is an apparatus that includes means for performing the method of any one of Examples 10 to 18. Example 26 is an apparatus that includes any combination of modules and/or units and/or logic and/or circuitry and/or means operative to perform the method of any one of Examples 10 to 18. Example 27 is an optionally non-transitory and/or tangible machine-readable medium, which optionally stores or otherwise provides instructions that if and/or when executed by a computer system or other machine are operative to cause the machine to perform the method of any one of Examples 10 to 18.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions and coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus comprising:
decoder circuitry to decode a single instruction, the single instruction to include a field for an identifier of a source operand, a field for an identifier of a destination operand, and a field for an opcode, the opcode to indicate execution circuitry is to perform a conditional jump operation; and
execution circuitry to execute the decoded instruction according to the opcode to perform the conditional jump operation to:
generate an exception when a value of the source operand is not a first value and not a second value,
execute a next instruction when the value of the source operand is the first value, and
jump to a destination indicated by the destination operand when the value of the source operand is the second value.

2. The apparatus of claim 1, wherein the field for the identifier of the source operand is to identify a register.

3. The apparatus of claim 1, wherein the field for the identifier of the source operand is to identify a memory location.

4. The apparatus of claim 1, wherein the source operand is to store a Boolean data type.

5. The apparatus of claim 4, wherein the source operand is to store decrypted memory data of the Boolean data type.

6. The apparatus of claim 1, wherein the source operand is to store a conditional data type.

7. The apparatus of claim 1, wherein when the source operand is to store an integer data type having an upper half and a lower half, the execution circuitry is to execute the decoded instruction according to the opcode to perform the conditional jump operation to generate an exception when a value of the upper half is not the first value.

8. The apparatus of claim 1, wherein the conditional jump operation is a Jump True operation and the first value is 0 and the second value is 1.

9. The apparatus of claim 1, wherein the conditional jump operation is a Jump False operation and the first value is 1 and the second value is 0.

10. A method, comprising:
fetching an instruction having fields for an opcode, a destination operand, and a source operand;
decoding the instruction according to the opcode;
retrieving data associated with the source operand;
scheduling execution of the decoded instruction; and
executing the decoded instruction to generate an exception when a value of the source operand is not a first value and not a second value, execute a next instruction when the value of the source operand is the first value, and jump to a destination indicated by the destination operand when the value of the source operand is the second value.

11. The method of claim 10, wherein the source operand is to identify a register.

12. The method of claim 10, wherein the source operand is to identify a memory location.

13. The method of claim 10, wherein the source operand is to store a Boolean data type.

14. The method of claim 13, wherein the source operand is to store decrypted memory data of the Boolean data type.

15. The method of claim 10, wherein the source operand is to store a conditional data type.

16. The method of claim 10, wherein when the source operand is to store an integer data type having an upper half and a lower half, further comprising executing the decoded instruction according to the opcode to generate an exception when a value of the upper half is not the first value.

17. The method of claim 10, wherein the instruction is a Jump True instruction and the first value is 0 and the second value is 1.

18. The method of claim 10, wherein the instruction is a Jump False instruction and the first value is 1 and the second value is 0.

19. An apparatus, comprising:
a processor coupled to a memory to perform a conditional jump operation; and
circuitry coupled to the processor and the memory to, in response to a single processor instruction, cause the processor to perform the conditional operation to generate an exception when a value of a source operand is not a first value and not a second value, execute a next instruction when the value of the source operand is the first value, and jump to a destination indicated by a destination operand when the value of the source operand is the second value.

20. The apparatus of claim 19, wherein the source operand is to store a Boolean data type.

21. The apparatus of claim 20, wherein the source operand is to store decrypted memory data of the Boolean data type.

22. The apparatus of claim 19, wherein the conditional jump operation is a Jump True operation and the first value is 0 and the second value is 1.

23. The apparatus of claim 19, wherein the conditional jump operation is a Jump False operation and the first value is 1 and the second value is 0.

24. At least one tangible machine-readable non-transitory medium comprising a plurality of instructions that in response to being executed by a processor cause the processor to:
fetch an instruction having fields for an opcode, a destination operand, and a source operand;
decode the instruction according to the opcode;
retrieve data associated with the source operand;
schedule execution of the decoded instruction; and
execute the decoded instruction to generate an exception when a value of the source operand is not a first value and not a second value, execute a next instruction when the value of the source operand is the first value, and jump to a destination indicated by the destination operand when the value of the source operand is the second value.

25. The at least one tangible machine-readable non-transitory medium of claim 24, wherein when the source operand is to store an integer data type having an upper half and a lower half, executing the decoded instruction according to the opcode to perform the conditional jump operation to generate an exception when a value of the upper half is not the first value.
